(19) United States
(12) Patent Application Publication
(10) Pub. No.: US 2021/0198009 A1
(43) Pub. Date: Jul. 1, 2021

(54) COLLAPSIBLE AND REUSABLE FOOD STORAGE CONTAINER

(71) Applicant: Apollonia M. Heinz, Seattle, WA (US)

(72) Inventor: Apollonia M. Heinz, Seattle, WA (US)

(21) Appl. No.: 17/116,303

(22) Filed: Dec. 9, 2020

Related U.S. Application Data
(60) Provisional application No. 62/945,596, filed on Dec. 9, 2019.

(51) Int. Cl. B65D 21/08; B65D 33/16

(52) U.S. Cl. CPC B65D 21/086; B65D 2543/00101; B65D 33/1658

(57) ABSTRACT

A collapsible and reusable food storage container is formed from a single, foldable sheet having a receptacle portion and a lid portion. The foldable sheet is formed from a plurality of planar panels positioned adjacent to one another, with a foldable seam spanning an offset formed between sets of the adjacent planar panels. In use, the foldable sheet may be repeatedly transitioned between a collapsed configuration in which the foldable sheet is folded about the foldable seam into a flat packet and an assembled configuration in which the foldable sheet is unfolded into a receptacle and an attached lid for securely storing a portion of food. The planar panels may be formed of polypropylene, while the foldable seam may be formed of silicone that is overlaid into the offset between adjacent panels and sonically welded to the edges of the adjacent planar panels. Other embodiments are also disclosed.

### REFERENCE TO PENDING PRIOR PATENT APPLICATION

This application claims the benefit under 35 U.S.C. 119(e) of U.S. Provisional Patent Application No. 62/945,596, filed Dec. 9, 2019 by Apollonia M. Heinz for “COLLAPSIBLE FOOD STORAGE CONTAINER,” which patent application is hereby incorporated herein by reference.

### BACKGROUND

Food storage containers are made in a variety of shapes, sizes, materials, and designs. Generally, collapsible “takeaway” or “to-go” storage containers for food and beverages are designed for one-time use and are formed from paper, cardboard, foil, or single-use plastic. These takeaway containers are used one time and disposed of thereafter.

Other collapsible food containers are formed from more robust materials and are reusable, but these containers generally include a collapsible receptacle and a separate lid that must be transported and/or stored alongside one another when not in use. Examples include the existing FoldFlat food container having a receptacle that folds into a separate retaining lid (http://foldflat.co.uk/) and a variety of accordion-style food containers that generally include a receptacle that may be collapsed and expanded similar to an accordion bellows to change the inner volume of the receptacle, along with a separate lid.

Existing collapsible container/lid combinations oftentimes rely on the separate lids to function a clamp or retaining device that “holds” the receptacle in its collapsed configuration, as is the case with the FoldFlat food container. As a result, the separate lid is required to maintain the receptacle in is collapsed state. Such separable lids are prone to separation or displacement from the receptacle, risking rendering the product useless for its intended purpose of sealed food storage.

Still other collapsible food storage containers utilize a flexible flat material in combination with snaps or other fasteners that are used to form a receptacle from the once flat, flexible material. The complexity of these structures renders them difficult to clean, stack, store, and transport. Moreover, many existing reusable, collapsible food containers are not designed for mass production and are not appropriate for use as takeaway or to-go containers. These containers are more expensive and are used for home, restaurant-kitchen, and/or industrial-kitchen use.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

One embodiment provides a collapsible and reusable food storage container. The collapsible and reusable food storage container may include a foldable sheet forming a receptacle portion and a lid portion, the foldable sheet comprising: (1) a plurality of planar panels, each of the plurality of the planar panels disposed at a defined offset from at least an adjacent one of the plurality of the planar panels; and (2) a foldable seam formed within the defined offset between each of the plurality of the planar panels and the at least the adjacent one of the plurality of the planar panels, wherein the foldable sheet transitions between a collapsed configuration in which the foldable sheet is folded about the foldable seam into a flat packet and an assembled configuration in which the foldable sheet is unfolded into a receptacle portion and an attached lid portion for securely storing a portion of food.

Another embodiment provides a collapsible and reusable storage container for food and beverages. The collapsible and reusable storage container may include a plurality of receptacle panels spaced apart from one another by a defined offset, wherein a flexible seam extends across the defined offset between adjacent ones of the plurality of the receptacle panels such that the plurality of the receptacle panels is selectively positionable between a flat packet configured for storage and a receptacle configured to receive a portion of food or a beverage. The container may also include an attached foldable lid.

Yet another embodiment provides a method of manufacturing a collapsible and reusable food storage container, comprising: (1) providing a plurality of receptacle panels; (2) positioning the plurality of the receptacle panels in a flat receptacle layout in which each of the plurality of the receptacle panels is separated by a defined offset from adjacent ones of the plurality of the receptacle panels; and (3) overlaying a flexible strip across the defined offset between the adjacent ones of the plurality of the receptacle panels to form a foldable receptacle seam within the defined offset, thereby forming a foldable receptacle sheet that transitions between a collapsed configuration that forms a flat packet and an assembled configuration that forms a receptacle for storing a portion of food or a beverage.

Other embodiments are also disclosed.

Additional objects, advantages and novel features of the technology will be set forth in part in the description which follows, and in part will become more apparent to those skilled in the art upon examination of the following, or may be learned from practice of the technology.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIGS. 1A-1C illustrate perspective views of one embodiment of a reusable, collapsible food storage container in collapsed, partially-assembled, and assembled configurations, respectively;

FIGS. 2A-2D illustrate the steps of an exemplary manufacturing process for the reusable, collapsible food storage container of FIGS. 1A-1C;

FIG. 3 provides a flowchart depicting an exemplary method of manufacturing an embodiment of the food storage container of FIGS. 1A-1C according to the steps illustrated in FIGS. 2A-2D;

FIGS. 4A-4D through 16A-16D illustrate an exemplary sequence of steps for assembling the reusable, collapsible food storage container of FIGS. 1A-1C from the collapsed configuration shown in the perspective, front, side, and top views of FIGS. 4A-4D, in which the container forms a slim, flat packet, into the assembled configuration shown in the perspective, front, side, and top views of FIGS. 16A-16D, in which the container forms a sealed food storage container.

FIG. 17 provides a flowchart depicting an exemplary method of assembling the food storage container of FIGS. 1A-1C according to the steps illustrated in FIGS. 4A-4D through 16A-16D;

FIG. 18 provides a flowchart depicting an exemplary method of collapsing the food storage container of FIGS. 1A-1C from the assembled configuration shown in FIGS. 16A-16D to the collapsed configuration shown in FIGS. 4A-4D;

FIG. 19 illustrates a perspective view of another embodiment of a reusable, collapsible food storage container in the form of a collapsible cup for the storage of liquid and/or solid food items;

FIGS. 20A-20C through 23A-23D illustrate an exemplary sequence of steps for assembling one embodiment of the reusable, collapsible cup of FIG. 19 from a collapsed configuration shown in the side, top, and front views of FIGS. 20A-20C, in which the collapsible cup forms a slim, flat packet, into an assembled configuration shown in the side, top, bottom, and front views of FIGS. 23A-23D, in which the cup forms a receptacle for liquid and/or food;

FIG. 24 provides a flowchart depicting an exemplary method of assembling the reusable, collapsible cup of FIG. 19 according to the steps illustrated in FIGS. 20A-20C through 23A-23D; and

FIG. 25 provides a flowchart depicting an exemplary method of collapsing the reusable, collapsible cup of FIG. 19 from the assembled configuration of FIGS. 23A-23D to the collapsed configuration of FIGS. 20A-20C.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

Various embodiments of the products and associated methods of manufacture and use described herein relate to reusable, collapsible food and beverage storage containers formed from a single, foldable sheet inspired by classic origami folding techniques. Embodiments of a collapsible food storage container provide a unique manner of transporting food to/from a restaurant or to/from any other location. Embodiments of the food storage container may repeatedly transition between a collapsed configuration, in which the container forms a slim, flat packet, and an assembled configuration, in which the container forms a receptacle or a receptacle with an attached lid configured to securely contain at least up to an entrée or main-course sized portion of food. When in the assembled configuration, the container simplifies the secure storage and transport of food within the container. Once the stored food is removed, the container may be cleaned for reuse or may be re-collapsed into its collapsed configuration, or into the slim, flat packet, for transport before being reassembled into the assembled configuration for cleaning. As a truly reusable food storage container, the container may be collapsed and assembled hundreds of times for repeated takeaway or to-go use.

Embodiments of the food storage container are designed such that when the container is collapsed into the collapsed configuration, all internal surfaces of the container face inward, thereby avoiding contamination of items that are external and adjacent to the container with surfaces that might interact with food while the container is in use to store food.

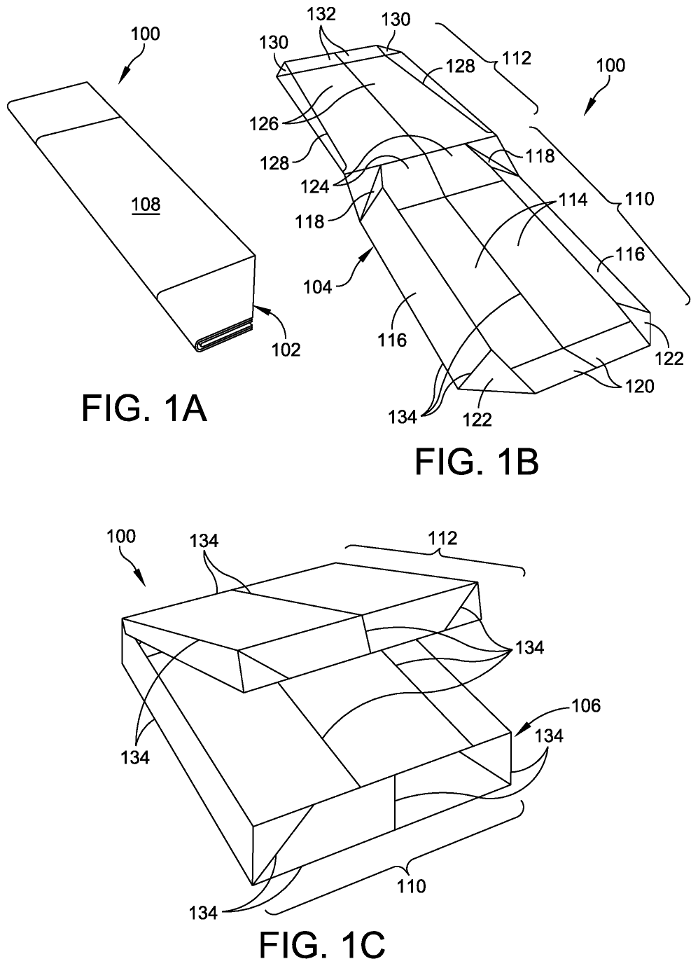

Turning to the figures, FIGS. 1A-1C illustrate one embodiment of a reusable, collapsible food storage container 100 in a collapsed configuration 102, a partially-assembled configuration 104, and an assembled configuration 106, respectively. In this embodiment, the reusable, collapsible food storage container 100 is formed from a single, foldable sheet 108 having a plurality of flexibly connected planar panels that combine to form a receptacle portion 110 and a lid portion 112. As detailed in FIG. 1B and in this embodiment, the panels forming the receptacle portion 110 may include two each of identical left and right bottom panels 114, receptacle side panels 116, receptacle locking tabs 118, receptacle front panels 120, receptacle tension panels 122, and receptacle rear panels 124. The panels forming the lid portion 112 may include two each of identical left and right lid top panels 126, lid side panels 128, lid tension panels 130, and lid front panels 132.

Each of the planar panels of the receptacle portion 110 and the lid portion 112 may be connected by a flexible or foldable seam 134, detailed further below, which enables the container 100 to be easily and conveniently folded from the assembled configuration 106 of FIG. 1C to the collapsed configuration 102 of FIG. 1A and vice versa.

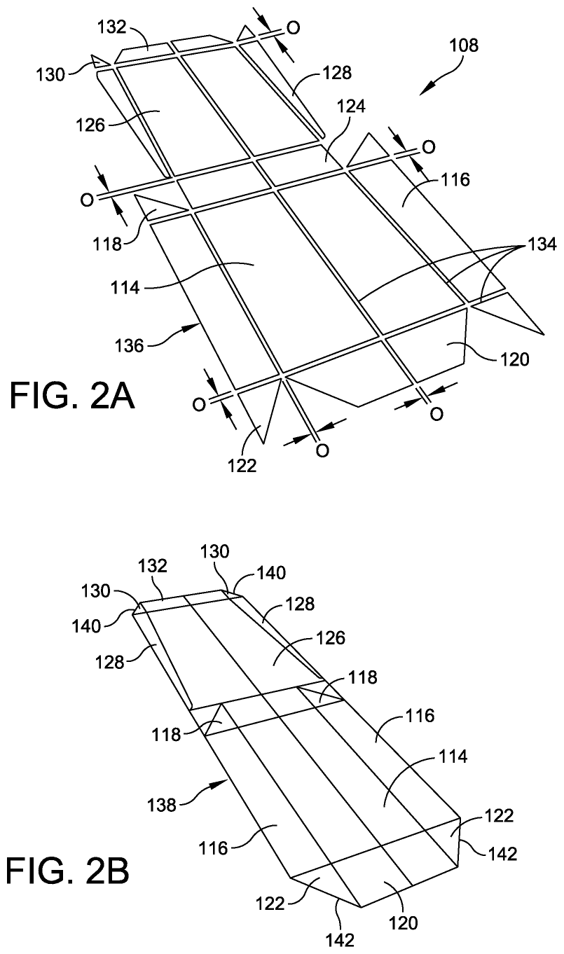

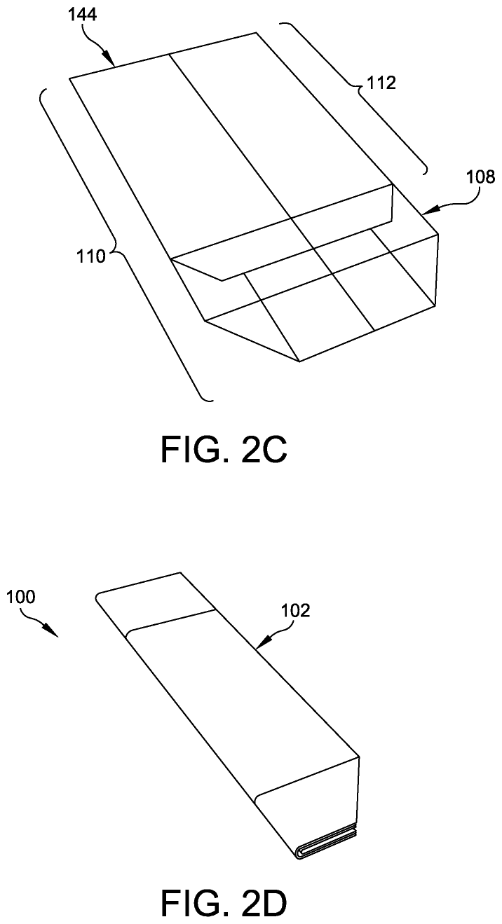

FIGS. 2A-2D illustrate the steps of an exemplary manufacturing process for the collapsible food storage container 100 of FIGS. 1A-1C, while FIG. 3 provides a flowchart depicting an exemplary method (200) of manufacturing an embodiment of the food storage container 100 according to the steps illustrated in FIGS. 2A-2D. In this embodiment, the planar panels 114-132 of the foldable sheet 108 discussed above may be arranged in a first flat layout or arrangement 136, as shown in FIG. 2A, such that each of the panels are disposed next to one another at a defined panel offset, O, (e.g., 1/32″, ⅛″) between each set of adjacent panels (FIG. 3, 202). The offset, O, is shown oversized and emphasized in FIG. 2A (only) for clarity purposes. Silicone or another suitably durable and flexible material may then be overlaid or layered in a bead or strip across the panel offset, O, and sonically welded to each panel edge to form the foldable flexible seam 134 between each set of adjacent panels (FIG. 3, 204).

Next, and as shown in FIG. 2B, the receptacle and the lid side panels 116, 128, the receptacle and the lid tension panels 122, 130, and the receptacle locking tabs 118 may be folded inward such that they are disposed directly on top of the adjacent panels, forming a second flat layout 138 (FIG. 3, 206), before the offsets newly formed between the lid tension panels 130 and the lid front panels 132 along seams 140 and between the receptacle tension panels 122 and the receptacle front panels 120 along seams 142 are overlaid with silicone that is sonically welded to the panel edges while positioned in the second flat layout 138 of FIG. 2B (FIG. 3, 208). This particular positioning of the panels, including the lid tension panels 130 disposed between the lid front panels 132 and the lid side panels 128 and the receptacle tension panels 122 disposed between the receptacle front panels 120 and the receptacle side panels 116, enables an inward biasing of the lid front and side panels 132, 128 and the receptacle front and side panels 120, 116 via the lid and the receptacle tension panels 130, 122, respectively, to maintain the lid portion 112 and the receptacle portion 110 in a vertical position when unfolded and assembled.

Once the silicone folding seams have been placed in the second flat layout 138 of FIG. 2B, the container is complete. The lid portion 112 may then be folded flat over the receptacle portion 110 to form a third flat layout 144, shown in FIG. 2C (FIG. 3, 210), and the entire foldable sheet 108, from the third flat layout 144, may be folded in half longitudinally to dispose the container in the collapsed configuration 102 of FIGS. 1A and 2D, in which the container 100 forms a slim, flat packet for easy transport (FIG. 3, 212).

The solid plastic planar panels add structure to the container 100 when in the assembled configuration 106 of FIG. 1C, while the flexible seams 134, 140, 142 add movement, direction, flexibility, and durability to the design. The inward folding of the storage container 100 into the collapsed configuration 102 of FIGS. 1A and 2D ensures there are no pockets where food may be exposed to the external environment once the container 100 is collapsed or folded from the assembled configuration 106 of FIG. 1C to the collapsed configuration 102 of FIGS. 1A and 2D. The container 100 is also devoid of any pockets, bubbles, or other features in which food may be caught or that may potentially complicate any cleaning and/or sanitization processes. Each of the flat, structured panels may be formed of polypropylene or another appropriate polymer, which may be ocean up-cycled and also recyclable. The polypropylene-panel-and-silicone-seam combination is reusable, leak resistant, food safe, freezer safe, microwave safe, and dishwasher safe.

In some embodiments, the panels and the foldable seams may be replaced by a single material having “living edges,” rather than folds, to increase recyclability of the product. Other embodiments may incorporate a leak-proof seal between the receptacle and the lid. Still other embodiments may be formed of any material or combination of materials that is appropriate and/or necessary.

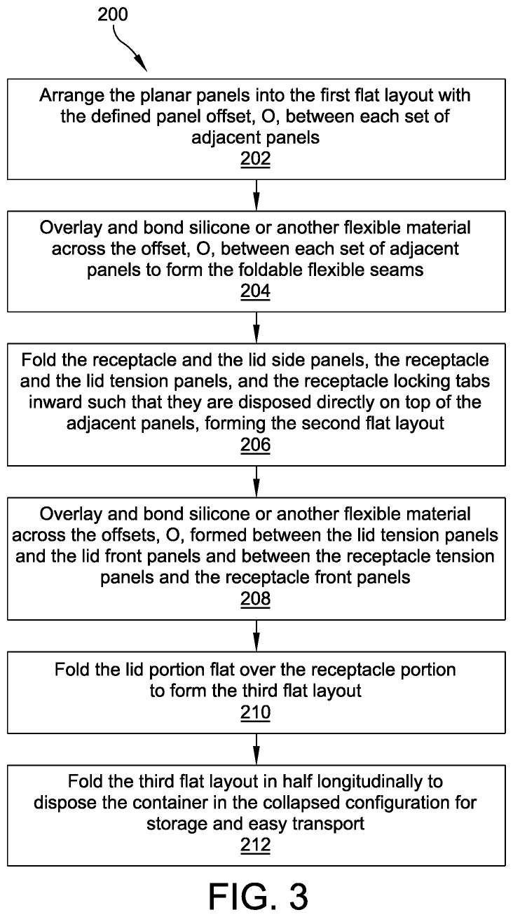

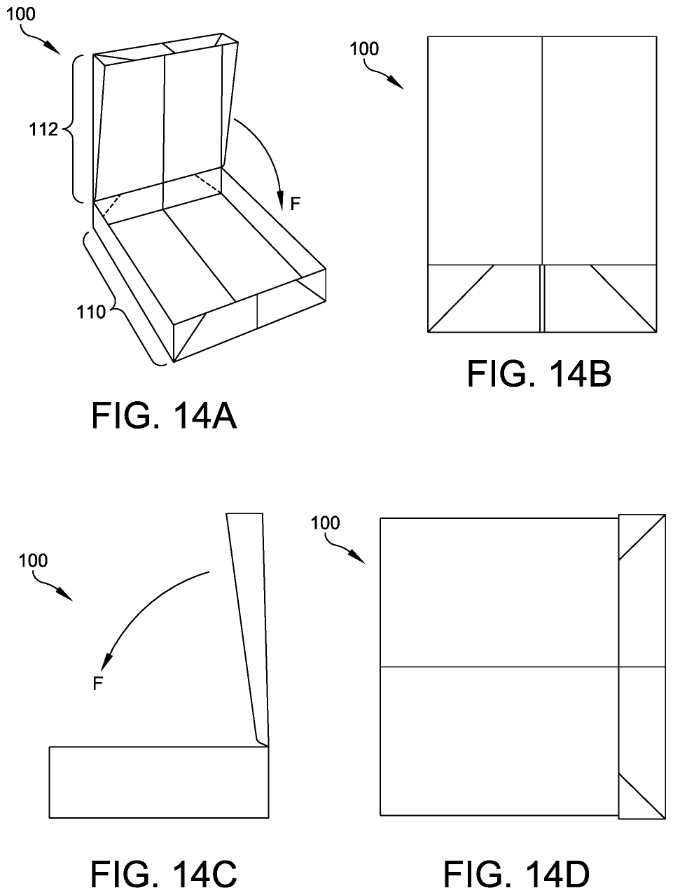

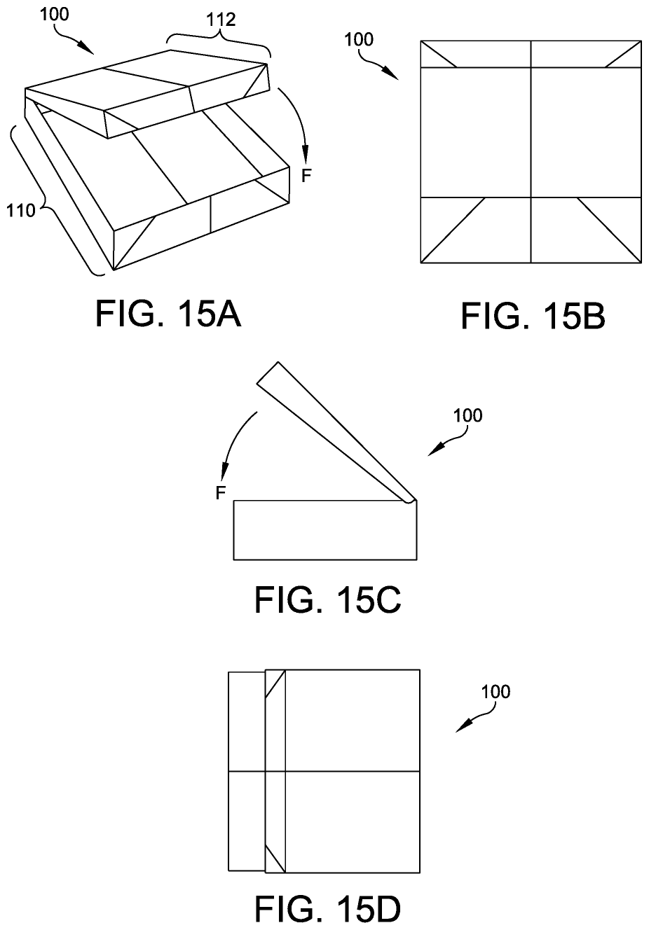

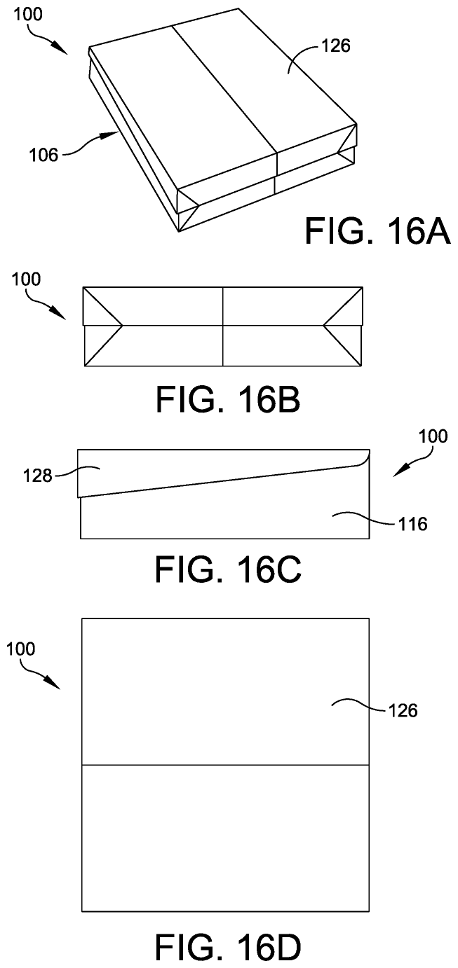

FIGS. 4A-4D through 16A-16D illustrate an exemplary sequence of steps for assembling one embodiment of the reusable, collapsible food storage container 100 from the collapsed configuration 102 shown in FIGS. 4A-4D, in which the container forms a slim, flat packet, into the assembled configuration 106 shown in FIGS. 16A-16D, in which the container forms a secure food receptacle and an attached lid for securely storing at least a main course or entrée-sized portion of food therein. FIG. 17 provides a flowchart depicting an exemplary method (250) of assembling the food storage container 100 according to the steps illustrated in FIGS. 4A-4D through 16A-16D. The method is simple and intuitive such that it may be performed by nearly all users across wide-ranging age groups.

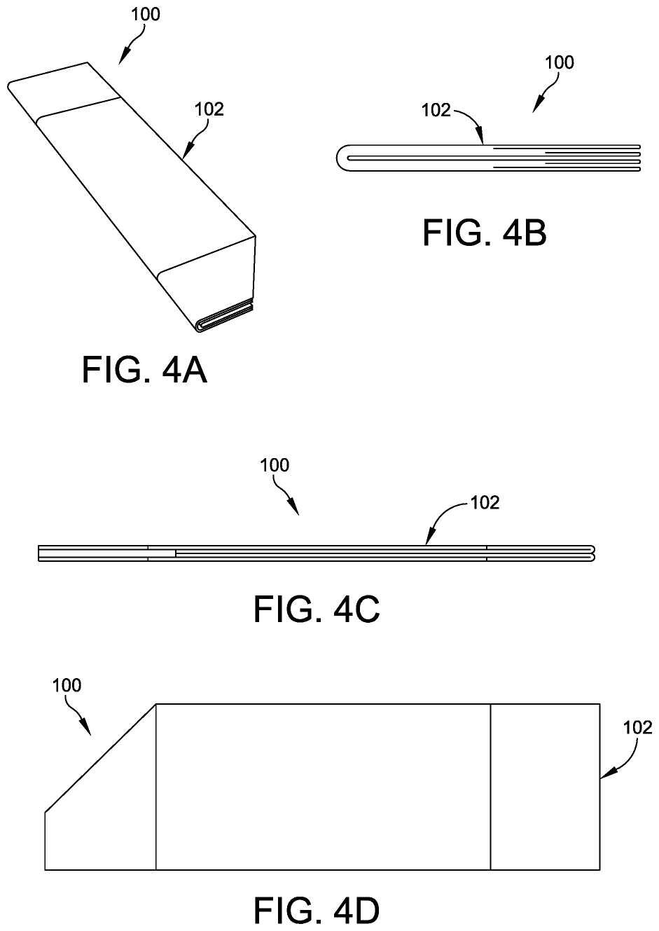

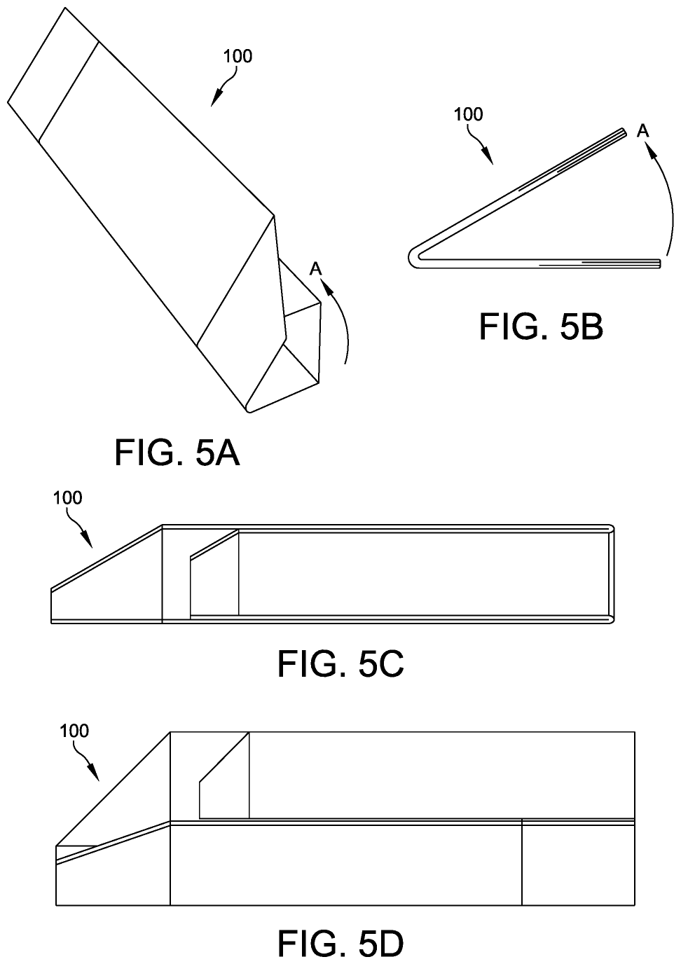

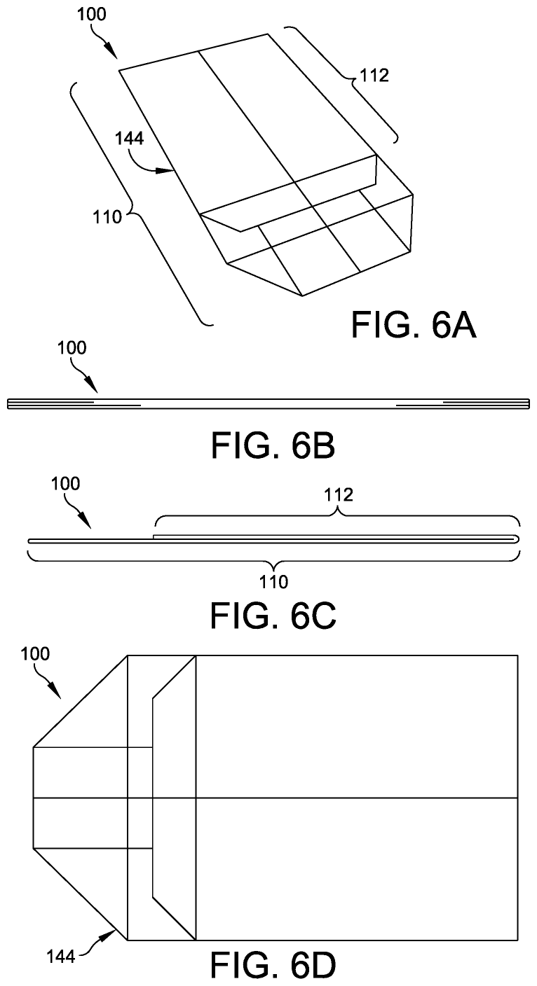

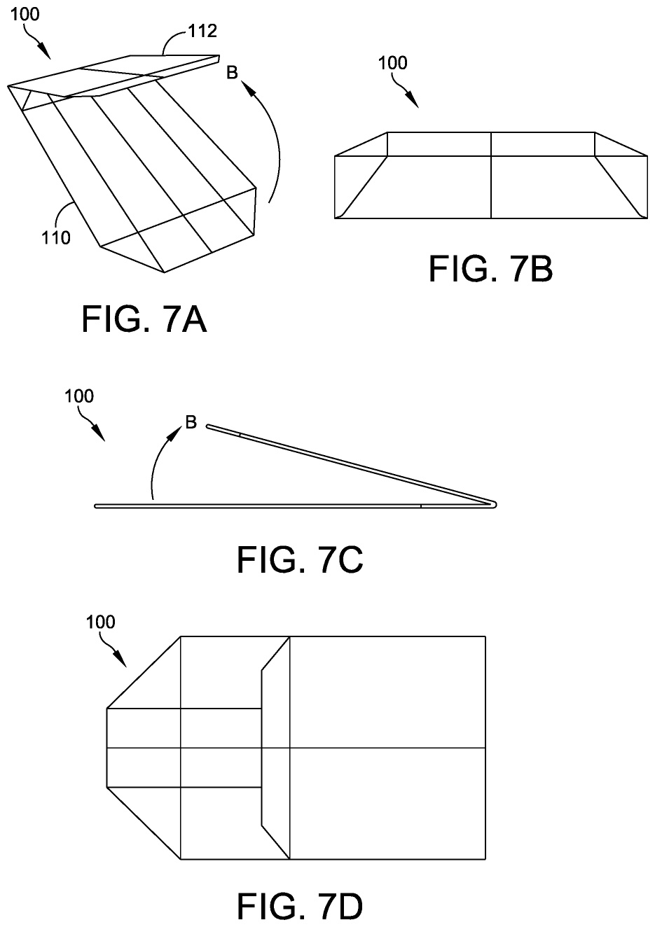

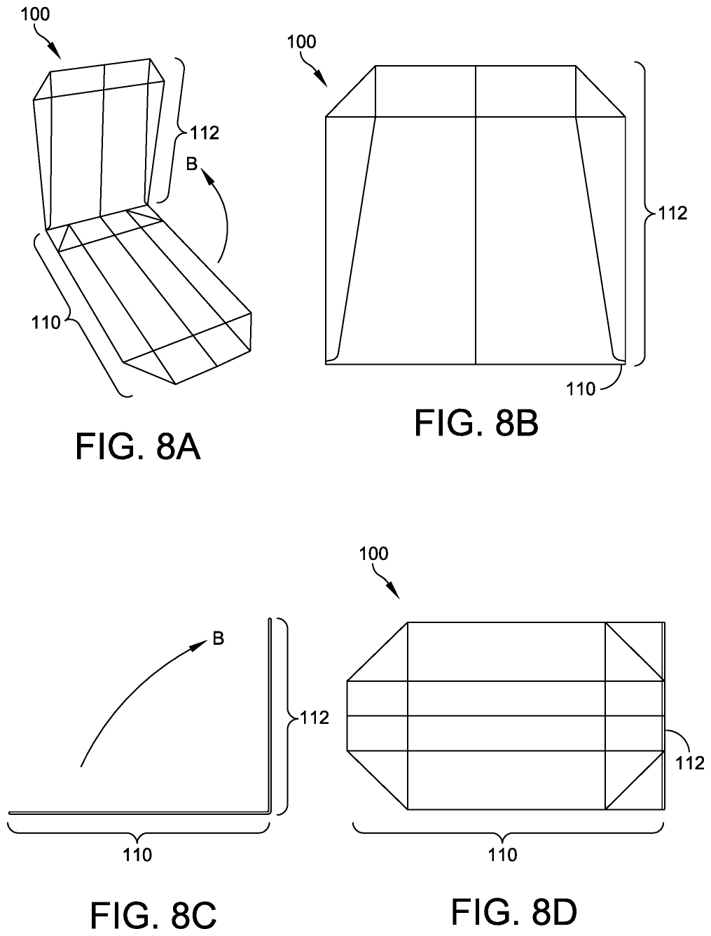

Starting from the collapsed configuration 102 shown in FIGS. 4A-4D, a user may longitudinally unfold the container 100 in the direction depicted by arrow A, as shown in FIG. 5A-5D, to transition the container 100 from the collapsed configuration 102 to the third flat layout 144 shown in FIGS. 6A-6D, in which the flattened lid portion 112 is disposed directly above or adjacent to the flattened receptacle portion 110 (FIG. 17, 252). Next, the user may arc the lid portion 112 upward and away from the receptacle portion 110 in the direction depicted by arrow B shown in FIGS. 7A-7D and FIGS. 8A-8D to transition the container 100 from the third flat layout 144 shown in FIGS. 6A-6D to the second flat layout 138 shown in FIGS. 9A-9D, in which the flattened lid portion 112 is coplanar with the flattened receptacle portion 110 (FIG. 17, 254).

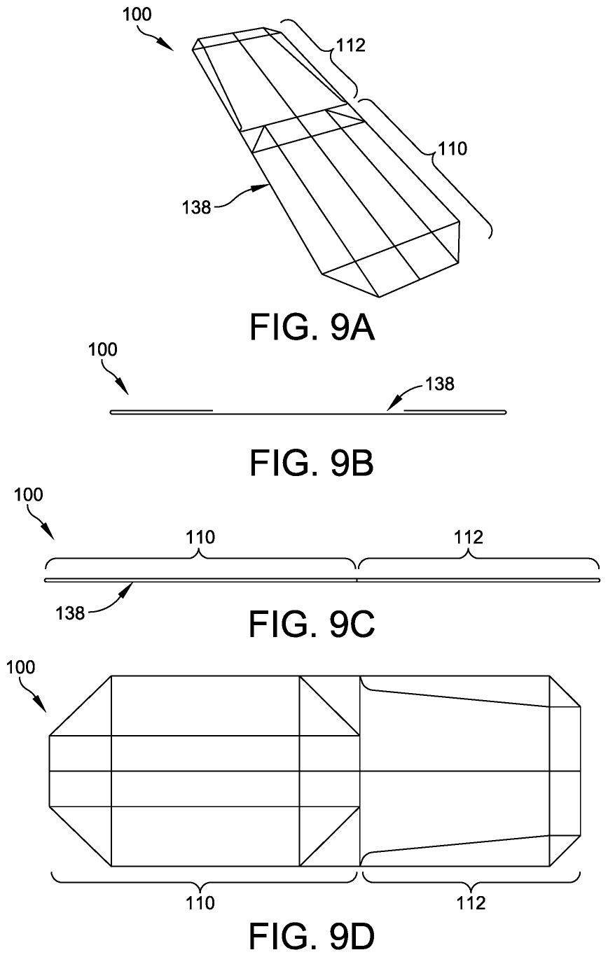

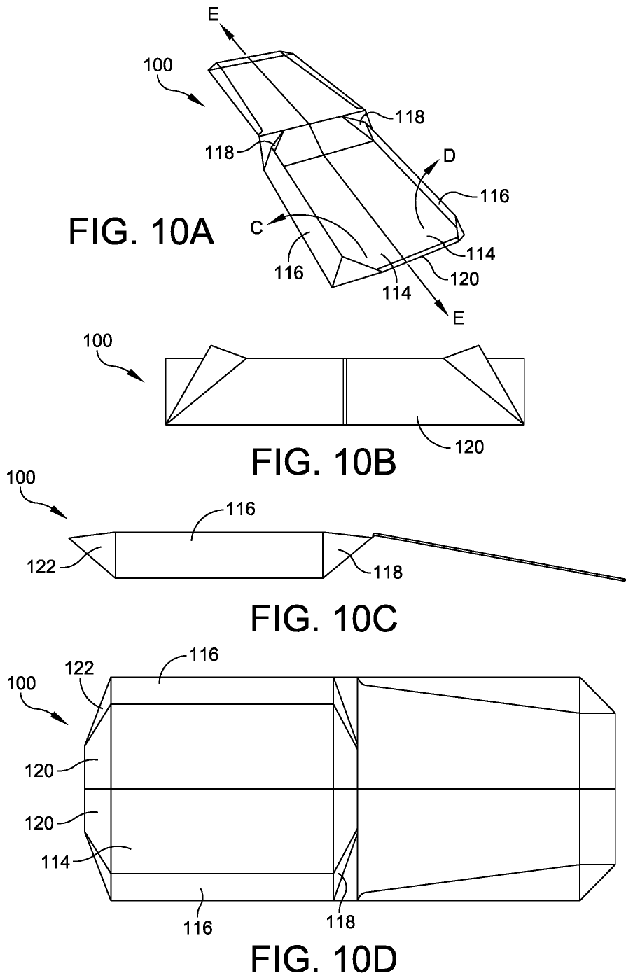

From the second flat layout 138 of FIGS. 9A-9D, the user may grasp the left and right receptacle side panels 116 and arc them upward and away from the left and right receptacle bottom panels 114 in the direction of arrows C and D, respectively, as shown in FIGS. 10A-10D, until the side panels 116 are disposed perpendicular to the bottom panels 114, as shown in FIGS. 11A-11D (FIG. 17, 256). Arcing the left and right receptacle side panels 116 upwards initiates a chain reaction that causes the receptacle front panels 120 to simultaneously straighten to a position that is perpendicular to the receptacle bottom panels 114, as shown in FIGS. 10A-10D and 11A-11D (FIG. 17, 258). Further, as the receptacle side panels 116 straighten to a position perpendicular to the bottom panels 114, the folding flexible seams 134, 142 begin to offer a resistance, pulling the receptacle side panels 116 toward a centerline of the receptacle, denoted by axis E (FIG. 17, 260). As the receptacle side panels 116 reach a full 90-degree angle to the bottom panels 114, the receptacle locking tabs 118 at the back edges of the left and right receptacle side panels 116 may wrap or “click” around a back of the respective receptacle rear panels 124, as shown in FIGS. 11A-11D (FIG. 17, 262). In parallel, the folding flexible seams 134, 142 continue to pull the receptacle side panels 116 toward the centerline of the receptacle, creating the resistance to maintain the receptacle portion 110 locked in an upright position (FIG. 17, 264).

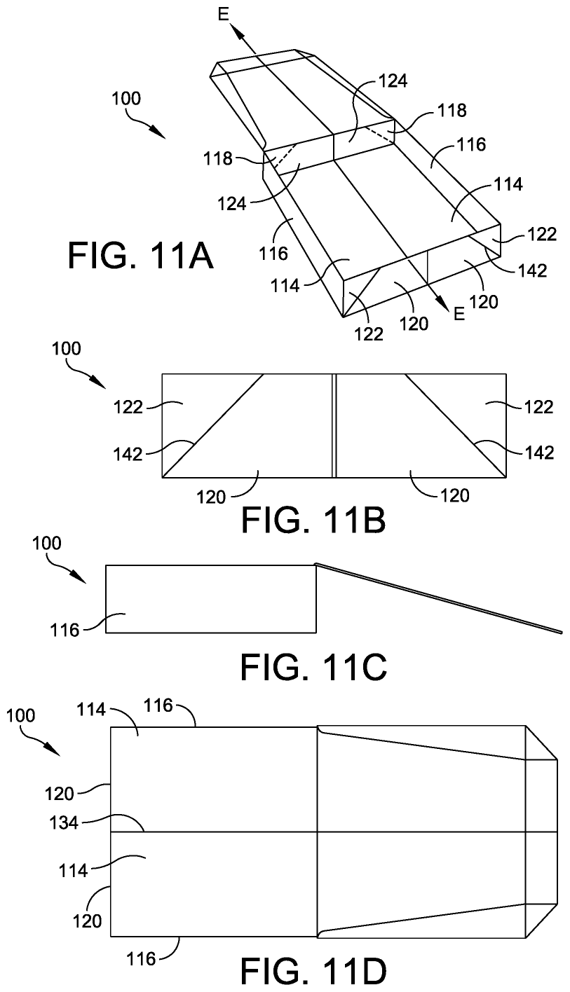

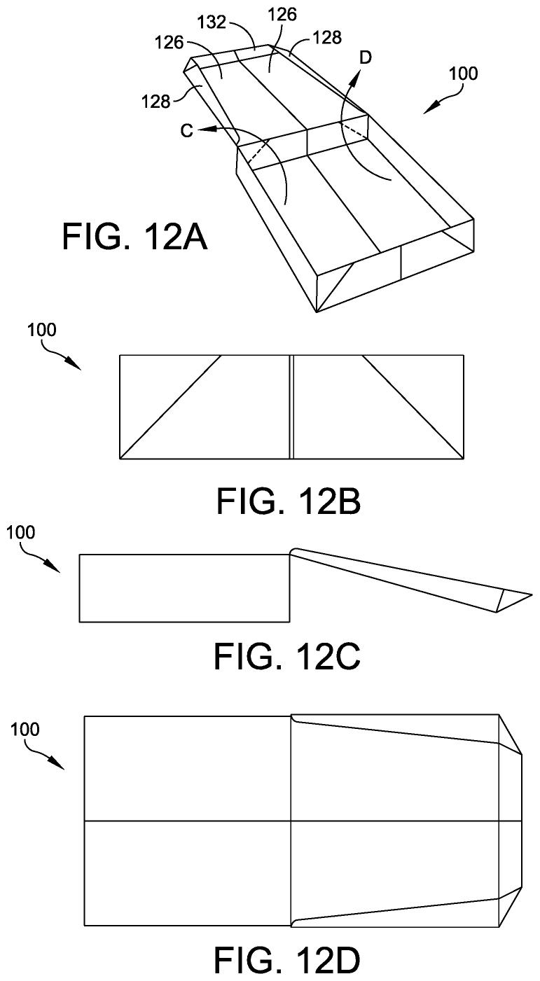

Turning to the lid portion 112 and in relation to FIGS. 12A-12D and 13A-13D, the user may arc the left and right lid side panels 128 away from the left and right lid top panels 126 in the direction of arrows C and D shown in FIGS. 12A-12D, respectively, into a perpendicular position relative to the top panels 126, shown in FIGS. 13A-13D (FIG. 17, 266). Similar to the receptacle portion 110, discussed above, this arcing motion causes a chain reaction that forces or automatically straightens the lid front panels 132 “forward” into a position perpendicular to the lid top panels 126, which constructs the rectangular form of the lid portion 112, as shown in FIGS. 13A-13D, resulting in the assembled configuration 106 of the container 100 (FIG. 17, 268).

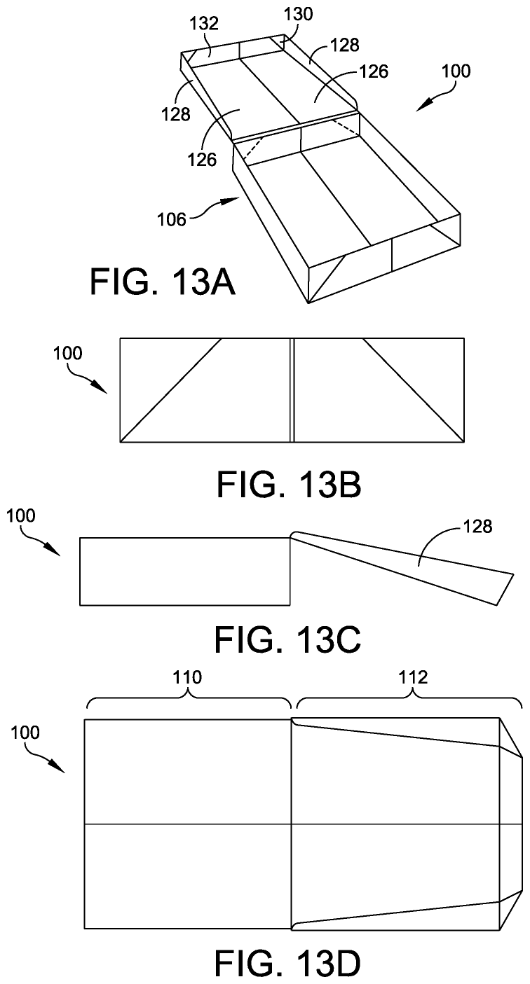

The lid portion 112 may then be arced in the direction depicted by arrow F toward the receptacle portion 110 to cover and enclose the top of the receptacle portion 110, as depicted in FIGS. 14A-14D through 16A-16D (FIG. 17, 270). In this embodiment, the lid portion 112 is sized and designed to be firmly pressed down about a perimeter of the receptacle portion 110, causing excess air to be expelled from the closed container 100, thereby creating a leak resistant seal between the receptacle portion 110 and the lid portion 112.

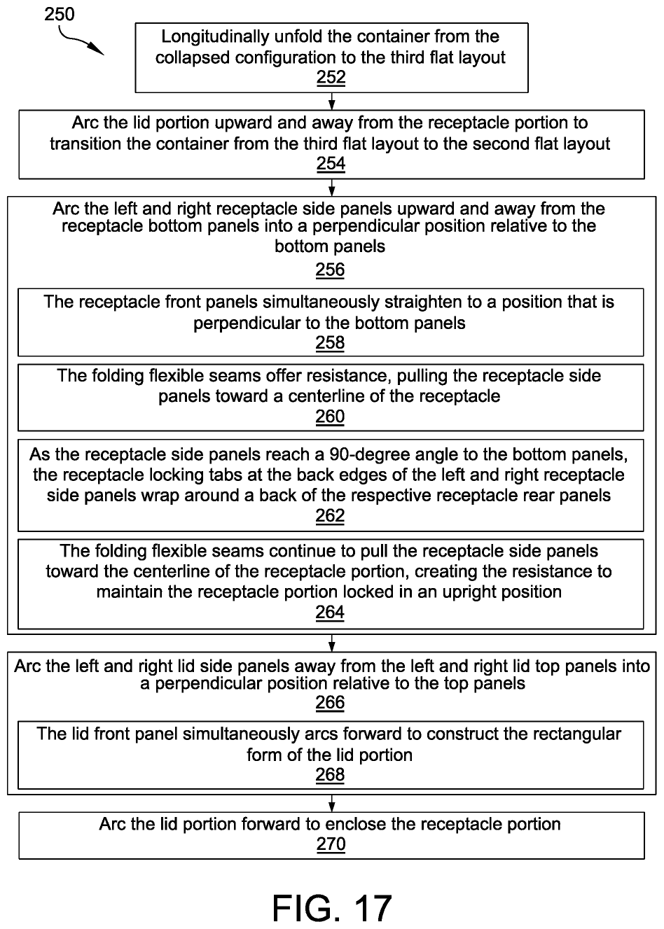

After the food storage container 100 has been emptied, the container 100 may be collapsed from the assembled configuration 106 of FIGS. 16A-16D into the collapsed configuration 102 of FIGS. 4A-4D by following the exemplary method (300) detailed in the flowchart of FIG. 18. Initially, the lid portion 112 may be arced away from the receptacle portion 110 (302). Then, the user may firmly pinch the left and right lid side panels 128 inward to collapse the lid portion 112 (304) before pulling the receptacle locking tabs 118 at the back of the receptacle portion 110 away from the centerline of the receptacle portion 110, thereby releasing the receptacle rear panels 124 and causing them, along with the receptacle side panels 116, to gently fold toward the centerline of the receptacle portion and return the container 100 to the second flat layout 138 (306). The final steps include folding or arcing the flattened lid portion 112 back down over the flattened receptacle portion 110 to return the container 100 to the third flat layout 144, covering any food debris that may be left inside the receptacle portion (308), before folding the entire foldable sheet, or the third flat layout 144, in half longitudinally to return the container 100 to the fully collapsed configuration 102 of FIGS. 1A and 4A-4D (310).

The elevated design of embodiments of the reusable, collapsible food storage container 100 convert a common waste item (a takeaway container) into a reusable, yet inexpensive, product that causes users to be more considerate of an item they usually consider trash. Embodiments of the disclosed storage container 100 may be at least partially made from ocean recycled and recycled plastics. The flat folding design will make it easier for people to have, on hand, a reusable food container at any time and/or place. The use of multiple materials in the design of this product increases the durability and perceived value of the container, while maintaining a cost effective product. The simple functionality of the container 100 renders it easy for people of all backgrounds to figure out the workings of assembly and collapse of the container. Having a food container that can contain large amounts of food, that can also be collapsed down to a flat packet, about the size and thickness of an iPad, makes for a highly useful and versatile product.

Embodiments of the reusable, collapsible food storage container 100 may be scaled to any appropriate size (e.g., from approximately a cupcake-size to a pizza-size) and may be employed by restaurants in providing to-go boxes to diners or used by diners desiring a highly portable food storage/to-go box on hand for transporting food to or from office, school, and/or community functions, for sending food items home with others, for carrying with the diner to a restaurant in anticipation of transporting leftovers home, and so on. Embodiments of the food storage container may be at least slightly heavier than the average disposable to-go packaging to encourage the perceived value of the container as compared to disposables.

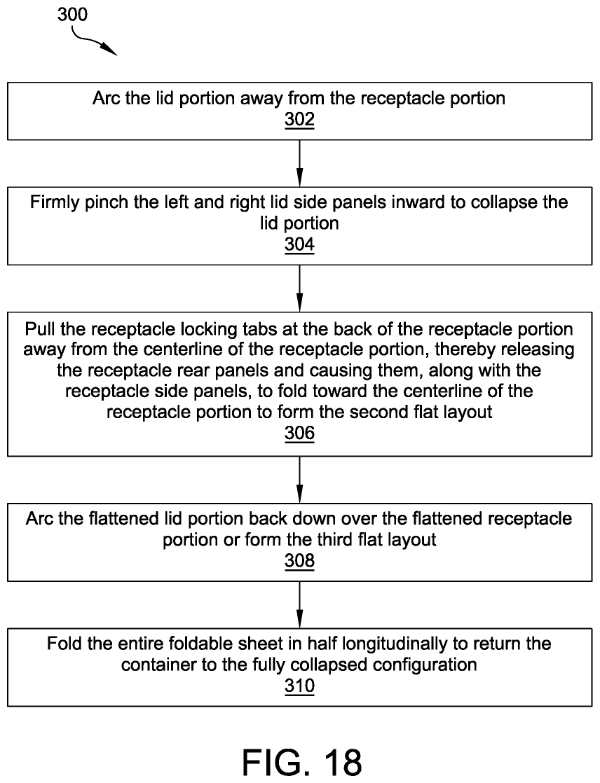

FIG. 19 illustrates a perspective view of another embodiment of a collapsible food storage container in the form of a collapsible cup 350 for the storage of liquid and/or food items, as desired. In this embodiment, the collapsible cup 350 may include identical and opposing front and rear flexible body panels 352, front and rear bottom panels 354, and left and right flexible side pockets 356. Similar to the collapsible food storage container 100, discussed above, the flexible body panels 352, the bottom panels 354, and the flexible side pockets 356 may be separated by flexible seams 358 bonded in offsets formed between adjacent panels. The flexible seams 358 allow the cup 350 to be manufactured as a single sheet, and enable collapsibility of the cup 350.

In one embodiment, the flexible body panels 352, the bottom panels 354, and the flexible side pockets 356 may be formed of polypropylene or another appropriate polymer, which may be ocean up-cycled and also recyclable. The flexible side pockets 356 may be sufficiently thin so as to be non-rigid or non-planar such that they may be manipulated in a manner similar to fabric. The flexible seams 358 may be formed of silicone or another suitably durable and flexible material overlaid across the offsets formed between the panels/pockets and sonically welded or otherwise bonded to each panel edge to form the foldable flexible seams 358 between each set of adjacent panels. The polypropylene-panel-and-silicone-seam combination is reusable, leak resistant, food safe, freezer safe, microwave safe, and dishwasher safe.

In one embodiment, the collapsible cup 350 may include an attached lid portion (not shown) formed from one or more collapsible lid panels attached to the flexible body panels 352 in a manner that allows the lid panels to fold flat with the remainder of the structure.

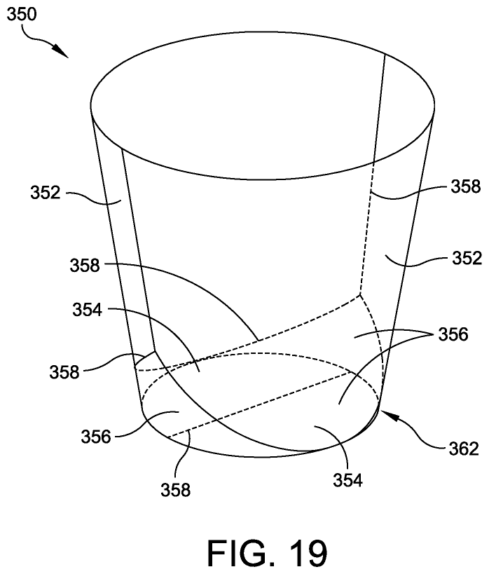

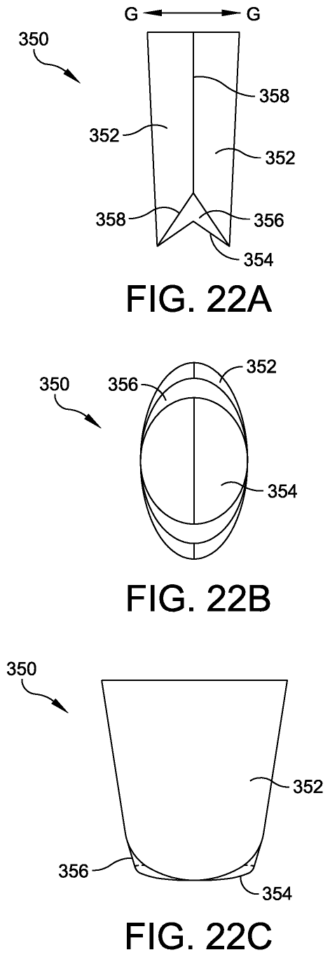

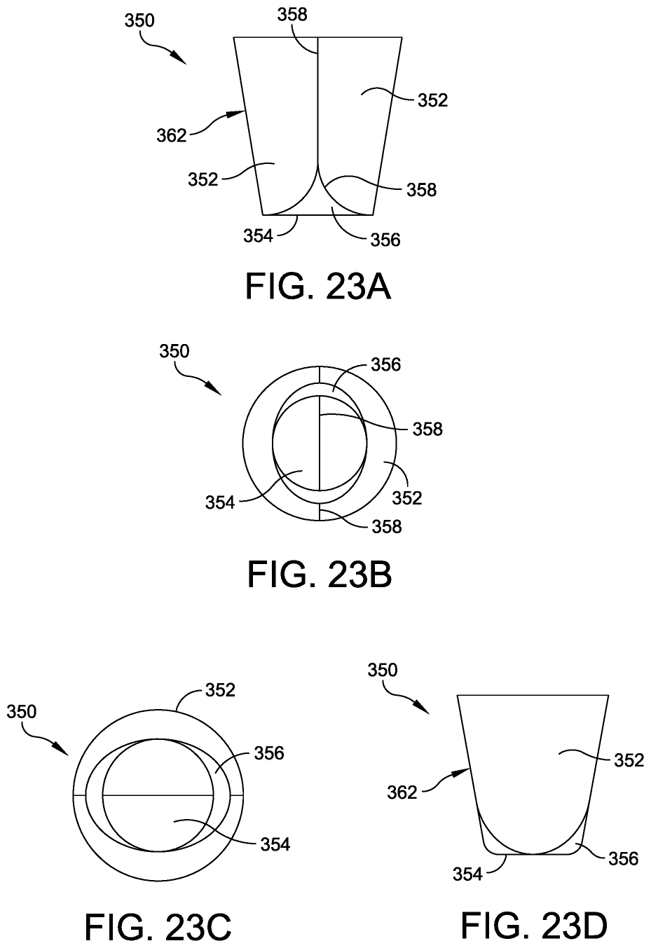

FIGS. 20A-20C through 23A-23D illustrate an exemplary sequence of steps for assembling one embodiment of the reusable, collapsible cup 350 from a collapsed configuration 360 shown in FIGS. 20A-20C, in which the collapsible cup 350 forms a slim, flat packet, into an assembled configuration 362 shown in FIGS. 23A-23D, in which the cup 350 forms a receptacle for liquid and/or food. FIG. 24 provides a flowchart depicting an exemplary method (400) of assembling the collapsible cup 350 according to the steps illustrated in FIGS. 20A-20C through 23A-23D.

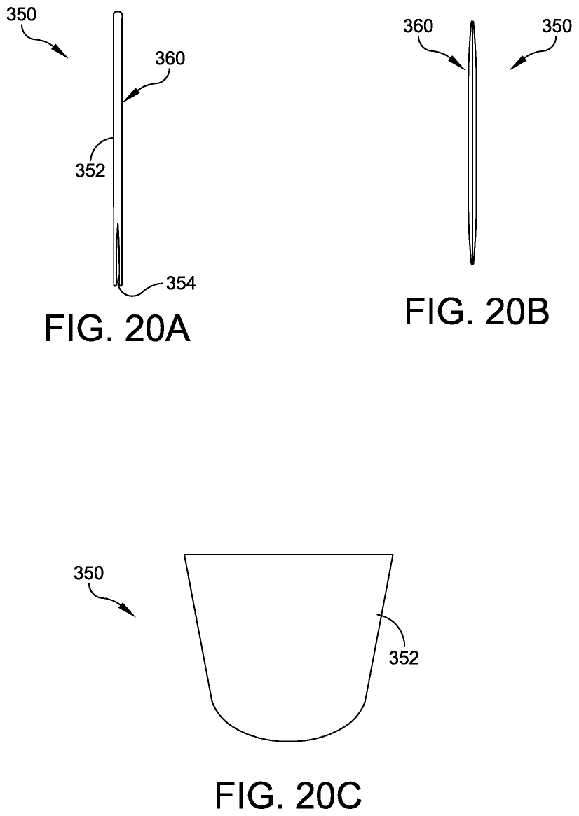

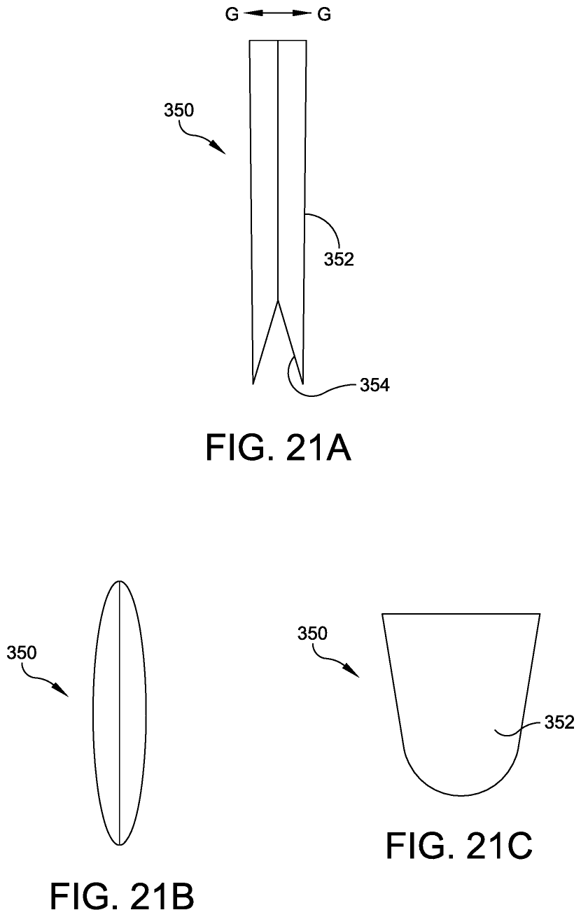

Starting from the collapsed, or flattened, configuration 360 of FIGS. 20A-20C, a user may pull the flexible body panels 352 in opposing directions away from one another along arrow G, as shown in FIGS. 21A-21C through FIGS. 22A-22C (FIG. 24, 402). In response, the bottom panels 354 simultaneously transition into a position that is coplanar to one another (FIG. 24, 404) and, in turn, the flexible side pockets are pulled taut between the retracted, and consequently rounded, opposing flexible body panels 352 and the coplanar bottom panels 354, as shown in FIGS. 23A-23D, thereby forming the assembled configuration 362 of the collapsible cup 350, shown in FIGS. 19 and 23A-23D (FIG. 24, 406).

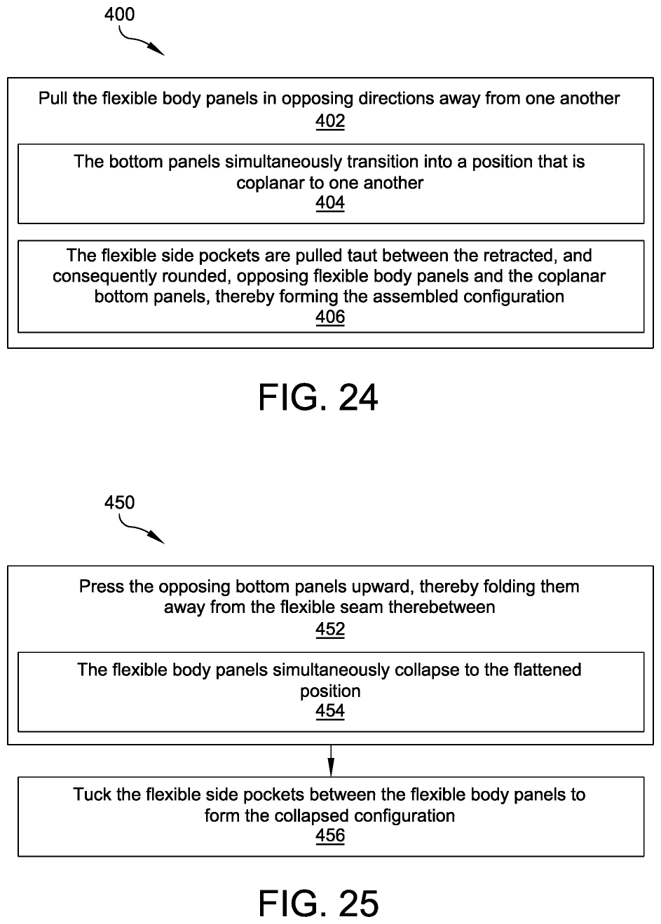

FIG. 25 provides a flowchart depicting an exemplary method (450) of collapsing the cup 350 from the assembled configuration 362 of FIGS. 19 and 23A-23D to the flattened or collapsed configuration 360 of FIGS. 20A-20C. To begin, the user may press the opposing bottom panels 354 upward (452), thereby folding them away from the flexible seam 358 therebetween and causing the entire cup structure to collapse such that the flexible body panels 352 return to the flattened position and the flexible side pockets 356 billow outward (454). The flexible side pockets may then be tucked between the flexible body panels 352 to form the collapsed configuration 360 of FIGS. 20A-20C for easy transport (456).

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. A collapsible and reusable food storage container, comprising:
a foldable sheet forming a receptacle portion and a lid portion, the foldable sheet comprising:
a plurality of planar panels, each of the plurality of the planar panels disposed at a defined offset from at least an adjacent one of the plurality of the planar panels; and
a foldable seam formed within the defined offset between each of the plurality of the planar panels and the at least the adjacent one of the plurality of the planar panels, wherein the foldable sheet transitions between a collapsed configuration in which the foldable sheet is folded about the foldable seam into a flat packet and an assembled configuration in which the foldable sheet is unfolded into a receptacle portion and an attached lid portion for securely storing a portion of food.

2. The collapsible and reusable food storage container of claim 1, wherein:
the lid portion of the foldable sheet comprises:
a left top panel and a right top panel;
a left lid side panel and a right lid side panel;
a left lid tension panel and a right lid tension panel; and
a left lid front panel and a right lid front panel; and
the receptacle portion of the foldable sheet comprises:
a left bottom panel and a right bottom panel;
a left receptacle side panel and a right receptacle side panel;
a left receptacle locking tab and right receptacle locking tab;
a left receptacle front panel and a right receptacle front panel;
a left receptacle tension panel and a right receptacle tension panel; and
a left receptacle rear panel and a right receptacle rear panel.

3. The collapsible and reusable food storage container of claim 2, wherein the foldable sheet is transitioned between the collapsible configuration and the assembled configuration by:
longitudinally unfolding the foldable sheet from the collapsed configuration to form a third flat layout in which the left and the right lid side panels confront the left and the right receptacle side panels;
arcing the lid portion away from the receptacle portion until the left and the right lid side panels and the left and the right receptacle side panels are coplanar;
arcing the left and the right receptacle side panels away from the left and the right receptacle bottom panels until the left and the right receptacle side panels are perpendicular to the left and the right receptacle bottom panels;
wrapping the left and the right receptacle locking tabs around a rear end of the left and the right receptacle rear panels; and
arcing the left and the right lid side panels away from the left and the right lid top panels until the left and the right lid side panels are perpendicular to the left and the right lid top panels.

4. The collapsible and reusable food storage container of claim 3, wherein the arcing the left and the right receptacle side panels away from the left and the right receptacle bottom panels causes the left and the right receptacle front panels to straighten to a position perpendicular to the left and the right receptacle bottom panels.

5. The collapsible and reusable food storage container of claim 3, wherein the arcing the left and the right lid side panels away from the left and the right lid top panels causes the left and the right lid front panels to straighten to a position perpendicular to the left and the right lid top panels.

6. The collapsible and reusable food storage container of claim 1, wherein each of the plurality of the planar panels is formed of polypropylene.

7. The collapsible and reusable food storage container of claim 6, wherein the foldable seam is formed of silicone overlaid within the defined offset between each of the plurality of the planar panels and the at least the adjacent one of the plurality of the planar panels.

8. The collapsible and reusable food storage container of claim 7, wherein the foldable sheet is food safe, microwave safe, freezer safe, and dishwasher safe.

9. A collapsible and reusable storage container for food and beverages, comprising:
a plurality of receptacle panels spaced apart from one another by a defined offset, wherein a flexible seam extends across the defined offset between adjacent ones of the plurality of the receptacle panels such that the plurality of the receptacle panels is selectively positionable between a flat packet configured for storage and a receptacle configured to receive a portion of food or a beverage.

10. The collapsible and reusable storage container of claim 9, wherein:
the receptacle comprises a box configured to receive the portion of food; and
the plurality of the receptacle panels comprises:
a left receptacle bottom panel positioned at the defined offset from a right receptacle bottom panel;
a left receptacle side panel, a left receptacle front panel, and a left receptacle rear panel, each positioned at the defined offset from a left side, a front side, and a rear side, respectively, of the left receptacle bottom panel;
a right receptacle side panel, a right receptacle front panel, and a right receptacle rear panel, each positioned at the defined offset from a right side, a front side, and a rear side, respectively, of the right receptacle bottom panel;
left and right receptacle tension panels positioned at the defined offset between each of the left receptacle side panel and the left receptacle front panel and the right receptacle side panel and the right receptacle front panel, respectively; and
left and right receptacle locking tabs positioned at the defined offset from the left receptacle side panel and the right receptacle side panel, respectively.

11. The collapsible and reusable storage container of claim 9, further comprising a plurality of lid panels spaced apart from the plurality of the receptacle panels and from one another by the defined offset, wherein:
the flexible seam extends across the defined offset between the plurality of the receptacle panels and the plurality of the lid panels such that the plurality of the lid panels is rotatively attached to the plurality of the receptacle panels; and
the flexible seam extends across the defined offset between adjacent ones of the plurality of the lid panels such that the plurality of the lid panels is selectively positionable between the flat packet and an attached lid configured to enclose the receptacle.

12. The collapsible and reusable storage container of claim 11, wherein the plurality of the lid panels comprises:
a left lid top panel positioned at the defined offset from a right lid top panel;
a left lid side panel and a left lid front panel, each positioned at the defined offset from a left side and a front side, respectively, of the left lid top panel;
a right lid side panel and a right lid front panel, each positioned at the defined offset from a right side and a front side, respectively, of the right lid top panel; and
left and right lid tension panels positioned at the defined offset between each of the left lid side panel and the left lid front panel and the right lid side panel and the right lid front panel, respectively.

13. The collapsible and reusable storage container of claim 9, wherein:
the receptacle forms a cup configured to receive the beverage; and
the plurality of the receptacle panels comprises:
a pair of opposing flexible body panels separated by the defined offset;
a pair of opposing bottom panels separated from the pair of the opposing flexible body panels and one another by the defined offset;
a first flexible side pocket positioned at the defined offset between the pair of the flexible body panels and the pair of the bottom panels on a first side of the pair of the flexible body panels; and
a second flexible side pocket positioned at the defined offset between the pair of the flexible body panels and the pair of the bottom panels on an opposing second side of the pair of the flexible body panels.

14. The collapsible and reusable storage container of claim 9, wherein:
the plurality of the receptacle panels is formed of polypropylene; and
the flexible seam is formed of silicone overlaid within the defined offset between each of the plurality of the receptacle panels.

15. A method of manufacturing a collapsible and reusable food storage container, comprising:
providing a plurality of receptacle panels;
positioning the plurality of the receptacle panels in a flat receptacle layout in which each of the plurality of the receptacle panels is separated by a defined offset from adjacent ones of the plurality of the receptacle panels; and
overlaying a flexible strip across the defined offset between the adjacent ones of the plurality of the receptacle panels to form a foldable receptacle seam within the defined offset, thereby forming a foldable receptacle sheet that transitions between a collapsed configuration that forms a flat packet and an assembled configuration that forms a receptacle for storing a portion of food or a beverage.

16. The method of claim 15, wherein:
the receptacle comprises a box configured to receive the portion of food; and
the positioning the plurality of the receptacle panels comprises:
positioning a left receptacle bottom panel at the defined offset from a right receptacle bottom panel;
positioning a left receptacle side panel, a left receptacle front panel, and a left receptacle rear panel at the defined offset from a left side, a front side, and a rear side, respectively, of the left receptacle bottom panel;
positioning a right receptacle side panel, a right receptacle front panel, and a right receptacle rear panel at the defined offset from a right side, a front side, and a rear side, respectively, of the right receptacle bottom panel;
positioning left and right receptacle tension panels at the defined offset between each of the left receptacle side panel and the left receptacle front panel and the right receptacle side panel and the right receptacle front panel, respectively; and
positioning left and right receptacle locking tabs at the defined offset from the left receptacle side panel and the right receptacle side panel, respectively.

17. The method of claim 15, further comprising:
providing a plurality of lid panels;
positioning the plurality of the lid panels in a flat lid layout in which each of the plurality of the lid panels is separated by the defined offset from adjacent ones of the plurality of the lid panels and from the flat receptacle layout;
overlaying the flexible strip across the defined offset between the flat lid layout and the flat receptacle layout to rotatively attach the flat lid layout to the flat receptacle layout; and
overlaying the flexible strip across the defined offset between the adjacent ones of the plurality of the lid panels to form a foldable lid seam within the defined offset, thereby forming a foldable lid sheet that transitions with the foldable receptacle sheet between the collapsed configuration that forms the flat packet and the assembled configuration that forms the receptacle, the receptacle comprising a sealable receptacle-and-lid combination for storing the portion of food or the beverage.

18. The method of claim 17, wherein the positioning the plurality of the lid panels comprises:
positioning a left lid top panel at the defined offset from a right lid top panel;
positioning a left lid side panel and a left lid front panel, each at the defined offset from a left side and a front side, respectively, of the left lid top panel;
positioning a right lid side panel and a right lid front panel, each at the defined offset from a right side and a front side, respectively, of the right lid top panel; and
positioning left and right lid tension panels at the defined offset between each of the left lid side panel and the left lid front panel and the right lid side panel and the right lid front panel, respectively.

19. The method of claim 17, wherein:
the plurality of the receptacle panels and the plurality of the lid panels are formed of polypropylene; and
the flexible strip is formed of silicone.

20. The method of claim 15, wherein:
the receptacle forms a cup configured to receive the beverage; and
the plurality of the receptacle panels comprises:
a pair of opposing flexible body panels separated by the defined offset;
a pair of opposing bottom panels separated from the pair of the opposing flexible body panels and one another by the defined offset;
a left flexible side pocket positioned at the defined offset between the pair of the flexible body panels and the pair of the bottom panels on a left side of the pair of the flexible body panels; and
a right flexible side pocket positioned at the defined offset between the pair of the flexible body panels and the pair of the bottom panels on a right side of the pair of the flexible body panels.
